(19) United States
(12) Patent Application Publication
(10) Pub. No.: US 2023/0020966 A1
(43) Pub. Date: Jan. 19, 2023

(54) SYSTEMS AND METHODS FOR OPERATING AN AUTONOMOUS VEHICLE

(71) Applicant: TUSIMPLE, INC., San Diego, CA (US)

(72) Inventors: Scott Douglas FOSTER, San Diego, CA (US); Neil M. OVERMON, Redwood City, CA (US); Erik Orlando PORTILLO, Sterling, VA (US); Zhujia SHI, San Diego, CA (US); Joyce TAM, Pleasanton, CA (US); Dishi LI, Ann Arbor, MI (US); Hunter Scott WILLOUGHBY, San Diego, CA (US)

(21) Appl. No.: 17/812,644

(22) Filed: Jul. 14, 2022

Related U.S. Application Data
(60) Provisional application No. 63/273,868, filed on Oct. 29, 2021.
(60) Provisional application No. 63/255,839, filed on Oct. 14, 2021.
(60) Provisional application No. 63/226,378, filed on Jul. 28, 2021.
(60) Provisional application No. 63/221,740, filed on Jul. 14, 2021.

(51) Int. Cl. B60W 60/00; B60W 30/18; B60W 40/04; G07B 15/06; G06V 20/58; G06V 20/56

(52) U.S. Cl. CPC B60W 60/0015; B60W 30/18163; B60W 40/04; G07B 15/063; G06V 20/582; G06V 20/588; B60W 2420/42; B60W 2552/10; B60W 2552/53; B60W 2556/40; B60W 2556/45

(57) ABSTRACT

An autonomous vehicle (AV) includes features that allows the AV to comply with applicable regulations and statues for performing safe driving operation. Example embodiments disclosed herein provide enhanced high-precision operation of an AV in low-speed environments, such as a toll booth facility or heavy traffic. One example method disclosed herein includes a control computer identifying a starting point of the toll booth facility on the roadway and a plurality of toll lanes associated with the toll booth facility; selecting a particular toll lane; determining a trajectory for the AV that extends through the particular toll lane; and in response to the autonomous vehicle arriving at the starting point for the toll booth facility, transmitting, over a subsystem interface to one or more drive subsystems of the AV, instructions configured to cause the drive subsystems to operate together to cause the AV to travel according to the trajectory.

### PRIORITY CLAIMS AND RELATED PATENT APPLICATIONS

This patent document claims the priority to and the benefits of U.S. Provisional Application No. 63/221,740 entitled “SYSTEM AND METHOD FOR AN AUTONOMOUS VEHICLE” filed on Jul. 14, 2021, U.S. Provisional Application No. 63/226,378 entitled “SYSTEM AND METHOD FOR AN AUTONOMOUS VEHICLE” filed on Jul. 28, 2021, U.S. Provisional Application No. 63/255,839 entitled “SYSTEM AND METHOD FOR AN AUTONOMOUS VEHICLE” filed on Oct. 14, 2021, and U.S. Provisional Application No. 63/273,868 entitled “SYSTEM AND METHOD FOR AN AUTONOMOUS VEHICLE” filed on Oct. 29, 2021. The entire disclosures of the aforementioned applications are hereby incorporated by reference as part of the disclosure of this application.

### TECHNICAL FIELD

The present disclosure relates generally to autonomous vehicles. More particularly, the present disclosure is related to operating an autonomous vehicle (AV) appropriately on public roads, highways, and locations with other vehicles or pedestrians.

### BACKGROUND

Autonomous vehicle technologies can provide vehicles that can safely navigate towards a destination with limited or no driver assistance. The safe navigation of an autonomous vehicle (AV) from one point to another may include the ability to signal other vehicles, navigating around other vehicles in shoulders or emergency lanes, changing lanes, biasing appropriately in a lane, and navigate all portions or types of highway lanes. Autonomous vehicle technologies may enable an AV to operate without requiring extensive learning or training by surrounding drivers, by ensuring that the AV can operate safely, in a way that is evident, logical, or familiar to surrounding drivers and pedestrians.

### SUMMARY

Systems and methods are described herein that can allow an autonomous vehicle (AV) to navigate from a first point to a second point. In some embodiments, the AV can navigate from the first point to the second point without a human driver present in the AV and to comply with instructions for safe and lawful operation.

In one exemplary aspect, a method for operating an autonomous vehicle is described. The method includes detecting, by a control computer located on the autonomous vehicle based on sensor data obtained over a subsystem interface between the control computer and one or more sensor subsystems of the autonomous vehicle, a toll booth facility that is located along a roadway through which a route for the autonomous vehicle extends. Detecting the toll booth facility includes identifying a starting point of the toll booth facility on the roadway and a plurality of toll lanes associated with the toll booth facility. The method further includes selecting, by the control computer, a particular toll lane of the plurality of toll lanes associated with the toll booth facility. The method further includes determining, by the control computer, a trajectory for the autonomous vehicle that extends through the particular toll lane. The method further includes transmitting, in response to the autonomous vehicle arriving at the starting point for the toll booth facility and by the control computer to one or more drive subsystems of the autonomous vehicle over the subsystem interface, a plurality of instructions that are configured to cause the one or more drive subsystems of the autonomous vehicle to operate together to cause the autonomous vehicle to travel in accordance with the trajectory until the autonomous vehicle is located at a toll booth associated with the particular toll lane.

In another exemplary aspect, another method for operating an autonomous vehicle is described. The method includes collecting, by a control computer located on the autonomous vehicle from one or more sensor subsystems of the autonomous vehicle over a subsystem interface, sensor data that captures a plurality of vehicles located within a portion of a roadway on which the autonomous vehicle is operating. The method further includes determining a classification for the plurality of vehicles that represents a degree of vehicular traffic present within the plurality of vehicles. The classification is determined from the sensor data based on a number of the plurality of vehicles, a relative distance between the vehicles, and an average vehicle speed. The method further includes, while the autonomous vehicle is located within a threshold distance of at least one of the plurality of vehicles, transmitting, by the control computer to one or more drive subsystems of the autonomous vehicle over the subsystem interface, instructions configured to cause the one or more drive subsystems of the autonomous vehicle to operate to cause the autonomous vehicle to travel at a speed that corresponds to the classification for the plurality of vehicles.

In yet another exemplary aspect, a system for operating an autonomous vehicle, comprising a computer that includes a processor configured to perform the methods described above and in this patent document.

In yet another exemplary aspect, the above-described methods and the methods described in this patent document are embodied in a non-transitory computer readable storage medium. The non-transitory computer readable storage medium includes code that when executed by a processor, causes the processor to perform the methods described in this patent document.

In another exemplary embodiment, a device that is configured or operable to perform the above-described methods is disclosed. In yet another exemplary embodiment, a system comprises a computer located in a vehicle, the computer comprises a processor configured to implement the above-described methods is disclosed.

The above and other aspects and their implementations are described in greater detail in the drawings, the descriptions, and the claims.

### BRIEF DESCRIPTION OF THE DRAWINGS

For a more complete understanding of this disclosure, reference is now made to the following brief description, taken in connection with the accompanying drawings and detailed description, where like reference numerals represent like parts.

FIG. 1 illustrates a block diagram of an example vehicle ecosystem of an autonomous vehicle.

FIG. 2 shows a flow diagram for safe operation of an autonomous vehicle safely in light of the health and/or surroundings of the autonomous vehicle.

FIG. 3 illustrates a system that includes one or more autonomous vehicles, a control center or oversight system with a human operator (e.g., a remote center operator (RCO)), and an interface for third-party interaction.

FIG. 4 shows an exemplary block diagram of a remote computer associated with an oversight system.

FIG. 5 shows an example flowchart of example operations for operating an autonomous vehicle.

FIG. 6 shows an example flowchart of example operations for operating an autonomous vehicle.

FIGS. 7A-7C illustrate diagrams of example toll booth facilities located along roadways that may be traveled by autonomous vehicles.

FIG. 8 illustrates a diagram of different portions of an example toll booth facility.

FIGS. 9A-9E illustrate example road signs that indicate a presence of a toll booth facility.

FIG. 10 illustrates a diagram of an autonomous vehicle being at a front distance away from a lead vehicle.

FIG. 11 illustrates a diagram of different portions of an example toll booth facility.

### DETAILED DESCRIPTION

Vehicles traversing highways and roadways are legally required to comply with regulations and statutes to ensure safe operation of the vehicle. For autonomous vehicles (AVs), particularly autonomous tractor trailers, the ability to recognize a malfunction in its systems and stop safely can allow for a lawful and safe operation of the vehicle. AVs such as commercial trucks and trucks with trailers often face road conditions and situations that may not be typically faced by private vehicle passengers and may be subject to different vehicular regulations under such circumstances. For example, a highway sign that indicates that commercial traffic needs to slow down on a winding road or pull into an inspection area or a weight station may not be applicable to passenger cars. A commercial autonomous vehicle, however, should notice such a sign and follow with an appropriate action according to the sign. Described below are systems and methods for, among other things, the safe and lawful operation of an autonomous vehicle on a roadway, including the execution of maneuvers that bring the autonomous vehicle in compliance with the law while signaling surrounding vehicles of its condition.

As will be understood, different operating environments for an autonomous vehicle may correspond to different levels of autonomous control and operation of the autonomous vehicle. In particular, in some examples, autonomous vehicles may operate within high-density and crowded environments in which a higher level of precision, control, and awareness of surrounding objects may be needed to safely navigate the autonomous vehicle. For example, in a toll booth facility, navigation of the autonomous vehicle is challenged by many neighboring vehicles and many environmental obstacles located within a relatively small area that features more complexity than other stretches of roadway. Such navigational challenges are magnified especially in examples in which the autonomous vehicle is a large-scale vehicle such as a truck. As another example, heavy traffic environments along a roadway include a high number of vehicles with a high density, and technical challenges exist with an autonomous vehicle navigating through and between the vehicles given the limited operational space of a roadway. Accordingly, embodiments described herein address technical challenges by enabling high-precision awareness and operation of an autonomous vehicle in a low-speed high-density environment.

This patent document describes in Section I below an example vehicle ecosystem of an autonomous vehicle and driving related operations of the autonomous vehicle. Section II describes a control center or oversight system for one or more autonomous vehicles, as well as various example features thereof and operations/processes performed thereby. Sections III to VI describe operations performed by the autonomous vehicle in various scenarios. The example headings for the various sections below are used to facilitate the understanding of the disclosed subject matter and do not limit the scope of the claimed subject matter in any way. Accordingly, one or more features of one example section can be combined with one or more features of another example section.

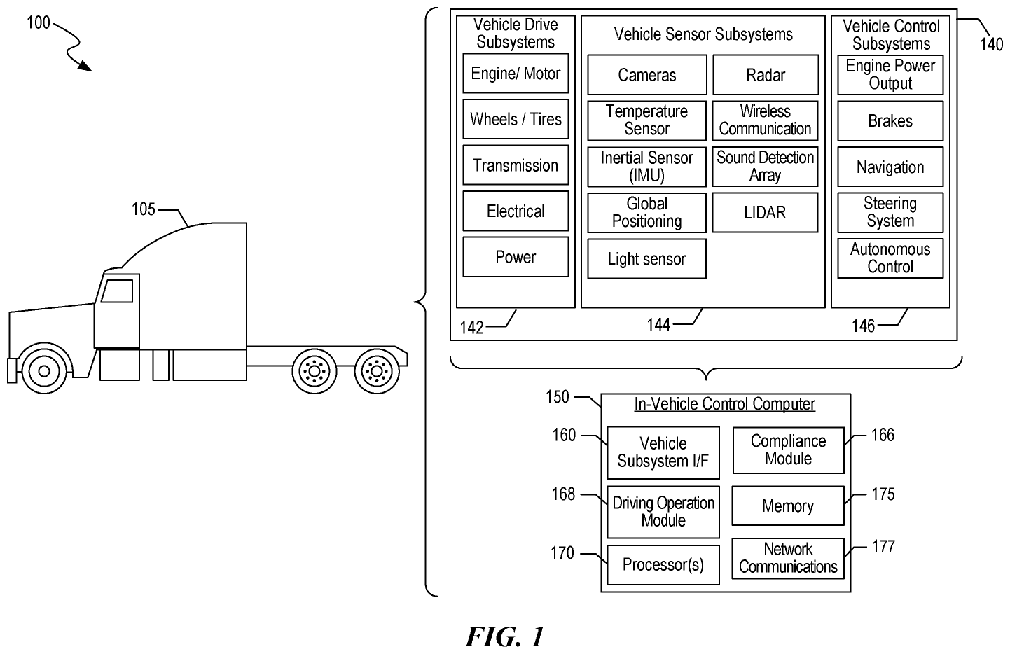

This patent document uses many abbreviations and uncommon terms. For instance, “GNSS” or “GPS” may refer to satellite navigation systems (global navigational satellite systems and global positioning system, respectively); when referring to an emergency vehicle, such as a police vehicle, ambulance, fire truck, tow truck, and the like, the abbreviation “EV” may be used; the acronym “TTC” indicates “time to collision”; “NPC” refers to non-player characters and may include any other vehicle that is not the autonomous vehicle in FIG. 1. For example, any surrounding vehicle, motorcycle, bicycle, and the like that are manually driven or autonomously driven and that may not be in communication with the autonomous vehicle may be considered NPC; a “k-ramp” denotes a freeway on/off ramp of a particular configuration; “STV” indicates a stopped vehicle; “ELV” may indicate an end-of-life or disabled vehicle, such as a disabled vehicle on a roadside; “OBO” may refer to an on-board operator or a human operator of an autonomous vehicle who temporarily takes control to assist during inspections, start-up, and/or ending of a trip or mission for the autonomous vehicle; and “LC” may be an abbreviation for lane change.

### I. EXAMPLE ECOSYSTEM OF AN AUTONOMOUS VEHICLE

FIG. 1 shows a system 100 that includes an autonomous vehicle 105. The autonomous vehicle 105 may include a tractor of a semi-trailer truck. The autonomous vehicle 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems 146. An engine or motor, wheels and tires, a transmission, an electrical subsystem, and a power subsystem may be included in the vehicle drive subsystems. The engine of the autonomous truck may be an internal combustion engine, a fuel-cell powered electric engine, a battery powered electrical engine, a hybrid engine, or any other type of engine capable of moving the wheels on which the autonomous vehicle 105 moves. The autonomous vehicle 105 have multiple motors or actuators to drive the wheels of the vehicle, such that the vehicle drive subsystems 142 include two or more electrically driven motors. The transmission may include a continuous variable transmission or a set number of gears that translate the power created by the engine into a force that drives the wheels of the vehicle. The vehicle drive subsystems may include an electrical system that monitors and controls the distribution of electrical current to components within the system, including pumps, fans, and actuators. The power subsystem of the vehicle drive subsystem may include components that regulate the power source of the vehicle. The vehicle drive subsystems 142 may be precisely operated based on instructions, such as commands, transmitted from the in-vehicle control computer 150. For example, the in-vehicle control computer 150 controls operation of the vehicle drive subsystems 142 via commands and instructions transmitted to the vehicle drive subsystems 142.

Vehicle sensor subsystems 144 can include sensors for general operation of the autonomous vehicle 105, including those which would indicate a malfunction in the autonomous vehicle or another cause for an autonomous vehicle to perform a limited or minimal risk condition (MRC) maneuver or an emergency driving maneuver. A driving operation module (shown as 168 in FIG. 1) can perform an MRC maneuver by sending instructions that cause the autonomous vehicle to steer along a trajectory to a side of the road and to apply brakes so that the autonomous vehicle can be safely stopped to the side of the road. The sensors for general operation of the autonomous vehicle may include cameras, a temperature sensor, an inertial sensor (IMU), a global positioning system, a light sensor, a LIDAR system, a radar system, and wireless communications.

A sound detection array, such as a microphone or array of microphones, may be included in the vehicle sensor subsystem 144. The microphones of the sound detection array are configured to receive audio indications of the presence of, or instructions from, authorities, including sirens and command such as “Pull over.” These microphones are mounted, or located, on the external portion of the vehicle, specifically on the outside of the tractor portion of an autonomous vehicle 105. Microphones used may be any suitable type, mounted such that they are effective both when the autonomous vehicle 105 is at rest, as well as when it is moving at normal driving speeds.

Cameras included in the vehicle sensor subsystems 144 may be rear-facing so that flashing lights from emergency vehicles may be observed from all around the autonomous truck 105. These cameras may include video cameras, cameras with filters for specific wavelengths, as well as any other cameras suitable to detect emergency vehicle lights based on color, flashing, of both color and flashing.

The vehicle control subsystem 146 may be configured to control operation of the autonomous vehicle, or truck, 105 and its components. Accordingly, the vehicle control subsystem 146 may include various elements such as an engine power output subsystem, a brake unit, a navigation unit, a steering system, and an autonomous control unit. The engine power output may control the operation of the engine, including the torque produced or horsepower provided, as well as provide control the gear selection of the transmission. The brake unit can include any combination of mechanisms configured to decelerate the autonomous vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more pre-determined maps so as to determine the driving path for the autonomous vehicle 105. The steering system may represent any combination of mechanisms that may be operable to adjust the heading of autonomous vehicle 105 in an autonomous mode or in a driver-controlled mode.

The autonomous control unit may represent a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the RADAR, the LiDAR (e.g., LIDAR), the cameras, and/or other vehicle subsystems to determine the driving path or trajectory for the autonomous vehicle 105. The autonomous control that may activate systems that the autonomous vehicle 105 has which are not present in a conventional vehicle, including those systems which can allow an autonomous vehicle to communicate with surrounding drivers or signal surrounding vehicles or drivers for safe operation of the autonomous vehicle.

An in-vehicle control computer 150, which may be referred to as a VCU, includes a vehicle subsystem interface 160, a driving operation module 168, one or more processors 170, a compliance module 166, a memory 175, and a network communications subsystem 178. This in-vehicle control computer 150 controls many, if not all, of the operations of the autonomous vehicle 105 in response to information from the various vehicle subsystems 140 that may be received over the vehicle subsystem interface 160. The one or more processors 170 execute the operations that allow the system to determine the health of the autonomous vehicle, such as whether the autonomous vehicle has a malfunction or has encountered a situation requiring service or a deviation from normal operation and giving instructions. Data from the vehicle sensor subsystems 144 is provided to VCU 150 (e.g., via vehicle subsystem interface 160) so that the determination of the status of the autonomous vehicle can be made. The compliance module 166 determines what action should be taken by the autonomous vehicle 105 to operate according to the applicable (e.g., local) regulations. Data from other vehicle sensor subsystems 144 may be provided to the compliance module 166 so that the best course of action in light of the autonomous vehicle's status may be appropriately determined and performed. Alternatively, or additionally, the compliance module 166 may determine the course of action in conjunction with another operational or control module, such as the driving operation module 168. The in-vehicle control computer 150 may then determine and transmit instructions (e.g., over the vehicle subsystem interface 160) to the vehicle drive subsystem 142 to cause the vehicle drive subsystem 142 to operate to cause certain operations of the autonomous vehicle.

The memory 175 may contain additional instructions as well, including instructions to transmit data to, receive data from, interact with, or control one or more of the vehicle drive subsystem 142, the vehicle sensor subsystem 144, and the vehicle control subsystem 146 including the autonomous Control system. The in-vehicle control computer (VCU) 150 may control the function of the autonomous vehicle 105 based on inputs received from various vehicle subsystems (e.g., the vehicle drive subsystem 142, the vehicle sensor subsystem 144, and the vehicle control subsystem 146). Additionally, the VCU 150 may send information to the vehicle control subsystems 146 to direct the trajectory, velocity, signaling behaviors, and the like, of the autonomous vehicle 105. For example, compliance module 166 and/or the driving operation module 168 in the VCU 150 may send instructions to one or more devices of the autonomous vehicle 105. The one or more devices may include one or more devices in the vehicle drive subsystems 142, the vehicle sensor subsystems 144, or the vehicle control subsystems 146. These instructions sent by the VCU 150 to one or more devices in the autonomous vehicle 105 are configured to effectuate and result in certain operations and actions being performed by the one or more devices in accordance with the instructions. Operations resulting from the instructions being sent to the one or more devices may together form driving related operations performed by the autonomous vehicle 105. For example, the VCU 150 may send instructions to a motor in the steering system, to an actuator in a brake unit, an/or to the engine to cause one or more devices to operate in accordance with the instructions such that the autonomous vehicle 105 performs a maneuver, or steers to follow a trajectory at a specified (e.g., via the instructions) velocity and/or acceleration/deceleration. Thus, the instructions provided by the VCU 150 can allow the autonomous vehicle 105 to follow a trajectory to steer from a current lane on which the autonomous vehicle 105 is operating to an adjacent lane or to a shoulder area (e.g., emergency stopping lane or area on side of the roadway) on the roadway. The autonomous control vehicle control subsystem may receive a course of action to be taken from the compliance module 166 of the VCU 150 and consequently relay instructions to other subsystems to execute the course of action. In Sections III to VI below, this patent document describes that the autonomous vehicle or a system performs certain functions or operations. These functions and/or the operations described can be performed by the compliance module 166 and/or the driving operation module 168.

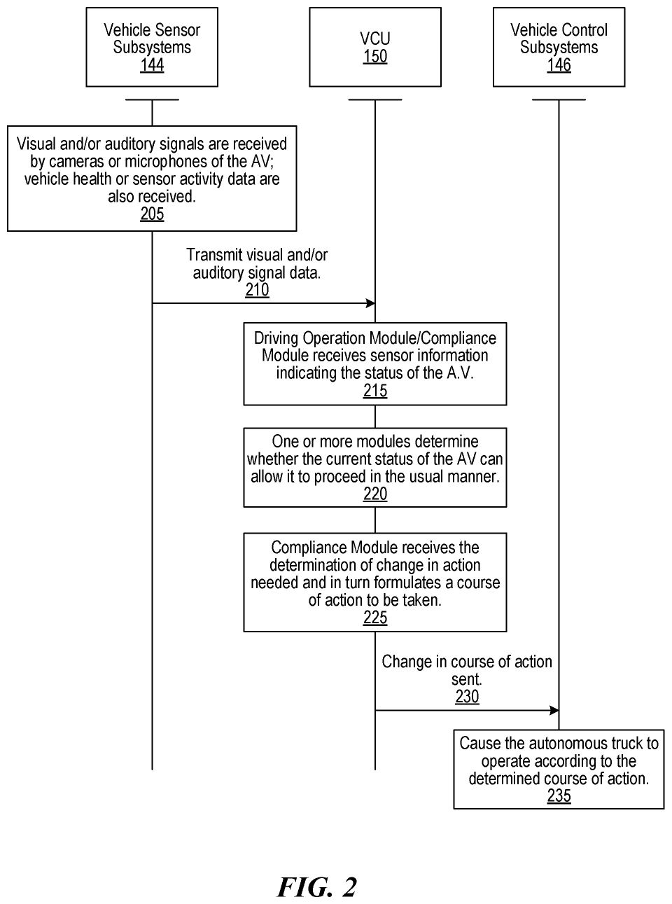

FIG. 2 shows a flow diagram for safe operation of an autonomous vehicle (AV) safely in light of the health and/or surroundings of the autonomous vehicle. Although this figure depicts functional steps in a particular order for purposes of illustration, the process is not limited to any particular order or arrangement of steps. One skilled in the relevant art will appreciate that the various steps portrayed in this figure may be omitted, rearranged, combined and/or adapted in various ways.

As shown in FIG. 2, the vehicle sensor subsystem 144 receives visual, auditory, or both visual and auditory signals indicating the at the environmental condition of the autonomous vehicle, as well as vehicle health or sensor activity data are received in step 205. These visual and/or auditory signal data are transmitted from the vehicle sensor subsystem 144 to the in-vehicle control computer system (VCU) 150, as in step 210. Any of the driving operation module and the compliance module receive the data transmitted from the vehicle sensor subsystem, in step 215. Then, one or both of those modules determine whether the current status of the autonomous vehicle can allow it to proceed in the usual manner or that the autonomous vehicle needs to alter its course to prevent damage or injury or to allow for service in step 220. The information indicating that a change to the course of the autonomous vehicle is needed may include an indicator of sensor malfunction; an indicator of a malfunction in the engine, brakes, or other components that may be necessary for the operation of the autonomous vehicle; a determination of a visual instruction from authorities such as flares, cones, or signage; a determination of authority personnel present on the roadway; a determination of a law enforcement vehicle on the roadway approaching the autonomous vehicle, including from which direction; and a determination of a law enforcement or first responder vehicle moving away from or on a separate roadway from the autonomous vehicle. This information indicating that a change to the autonomous vehicle's course of action or driving related operation is needed may be used by the compliance module to formulate a new course of action to be taken which accounts for the autonomous vehicle's health and surroundings, in step 225. The course of action to be taken may include slowing, stopping, moving into a shoulder, changing route, changing lane while staying on the same general route, and the like. The course of action to be taken may include initiating communications with any oversight or human interaction systems present on the autonomous vehicle. The course of action to be taken may then be transmitted from the VCU 150 to the autonomous control system, in step 230. The vehicle control subsystems 146 then cause the autonomous vehicle 105 to operate in accordance with the course of action to be taken that was received from the VCU 150 in step 235.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

### II. AUTONOMOUS VEHICLE OVERSIGHT SYSTEM

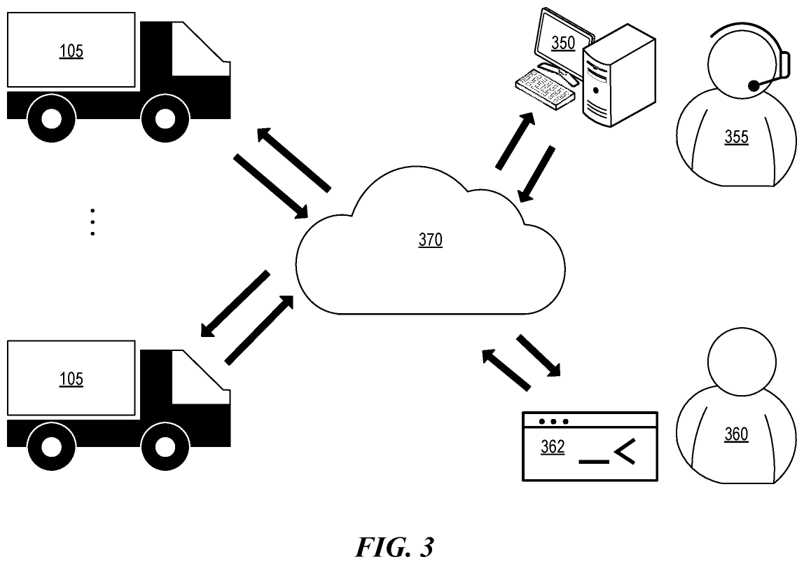

FIG. 3 illustrates a system 300 that includes one or more autonomous vehicles 105, a control center or oversight system 350 with a human operator 355, and an interface 362 for third-party 360 interaction. A human operator 355 may also be known as a remoter center operator (RCO). Communications between the autonomous vehicles 105, oversight system 350 and user interface 362 take place over a network 370. In some instances, where not all the autonomous vehicles 105 in a fleet are able to communicate with the oversight system 350, the autonomous vehicles 105 may communicate with each other over the network 370 or directly. As described with respect to FIG. 1, the VCU 150 of each autonomous vehicle 105 may include a module for network communications 178.

An autonomous truck may be in communication with an oversight system. The oversight system may serve many purposes, including: tracking the progress of one or more autonomous vehicles (e.g., an autonomous truck); tracking the progress of a fleet of autonomous vehicles; sending maneuvering instructions to one or more autonomous vehicles; monitoring the health of the autonomous vehicle(s); monitoring the status of the cargo of each autonomous vehicle in contact with the oversight system; facilitate communications between third parties (e.g., law enforcement, clients whose cargo is being carried) and each, or a specific, autonomous vehicle; allow for tracking of specific autonomous trucks in communication with the oversight system (e.g., third-party tracking of a subset of vehicles in a fleet); arranging maintenance service for the autonomous vehicles (e.g., oil changing, fueling, maintaining the levels of other fluids); alerting an affected autonomous vehicle of changes in traffic or weather that may adversely impact a route or delivery plan; pushing over the air updates to autonomous trucks to keep all components up to date; and other purposes or functions that improve the safety for the autonomous vehicle, its cargo, and its surroundings. An oversight system may also determine performance parameters of an autonomous vehicle or autonomous truck, including any of: data logging frequency, compression rate, location, data type; communication prioritization; how frequently to service the autonomous vehicle (e.g., how many miles between services); when to perform a minimal risk condition (MRC) maneuver while monitoring the vehicle's progress during the maneuver; when to hand over control of the autonomous vehicle to a human driver (e.g., at a destination yard, in a rescue situation); ensuring an autonomous vehicle passes pre-trip inspection; ensuring an autonomous vehicle performs or conforms to legal requirements at checkpoints and weight stations; ensuring an autonomous vehicle performs or conforms to instructions from a human at the site of a roadblock, cross-walk, intersection, construction, or accident; and the like.

Included in some of the functions executed by an oversight system or command center is the ability to relay over-the-air, real-time weather updates to autonomous vehicles in a monitored fleet. The over-the-air weather updates may be pushed to all autonomous vehicles in the fleet or may be pushed only to autonomous vehicles currently on a mission to deliver a cargo. Alternatively, or additionally, priority to push or transmit over-the-air weather reports may be given to fleet vehicles currently on a trajectory or route that leads towards or within a pre-determined radius of a severe weather event.

Another function that may be encompassed by the functions executed by an oversight system or command center is the transmission of trailer metadata to the autonomous vehicle's computing unit (VCU) prior to the start of a cargo transport mission. The trailer metadata may include the type of cargo being transmitted, the weight of the cargo, temperature thresholds for the cargo (e.g., trailer interior temperature should not fall below or rise above pre-determined temperatures), time-sensitivities, acceleration/deceleration sensitivities (e.g., jerking motion may be bad because of the fragility of the cargo), trailer weight distribution along the length of the trailer, cargo packing or stacking within the trailer, and the like.

An oversight system or command center may be operated by one or more human, also known as an operator or a remote center operator (RCO). The operator may set thresholds for autonomous vehicle health parameters, so that when an autonomous vehicle meets or exceeds the threshold, precautionary action may be taken. Examples of vehicle health parameters for which thresholds may be established by an operator may include any of: fuel levels; oil levels; miles traveled since last maintenance; low tire-pressure detected; cleaning fluid levels; brake fluid levels; responsiveness of steering and braking subsystems; Diesel exhaust fluid (DEF) level; communication ability (e.g., lack of responsiveness); positioning sensors ability (e.g., GPS, IMU malfunction); impact detection (e.g., vehicle collision); perception sensor ability (e.g., camera, LIDAR, radar, microphone array malfunction); computing resources ability (e.g., VCU or ECU malfunction or lack of responsiveness, temperature abnormalities in computing units); angle between a tractor and trailer in a towing situation (e.g., tractor-trailer, 18-wheeler, or semi-truck); unauthorized access by a living entity (e.g., a person or an animal) to the interior of an autonomous truck; and the like. The precautionary action may include execution of a minimal risk condition (MRC) maneuver, seeking service, or exiting a highway or other such re-routing that may be less taxing on the autonomous vehicle. An autonomous vehicle whose system health data meets or exceeds a threshold set at the oversight system or by the operator may receive instructions that are automatically sent from the oversight system to perform the precautionary action.

The operator may be made aware of situations affecting one or more autonomous vehicles in communication with or being monitored by the oversight system that the affected autonomous vehicle(s) may not be aware of. Such situations may include: irregular or sudden changes in traffic flow (e.g., traffic jam or accident); abrupt weather changes; abrupt changes in visibility; emergency conditions (e.g., fire, sink-hole, bridge failure); power outage affecting signal lights; unexpected road work; large or ambiguous road debris (e.g., object unidentifiable by the autonomous vehicle); law enforcement activity on the roadway (e.g., car chase or road clearing activity); and the like. These types of situations that may not be detectable by an autonomous vehicle may be brought to the attention of the oversight system operator through traffic reports, law enforcement communications, data from other vehicles that are in communication with the oversight system, reports from drivers of other vehicles in the area, and similar distributed information venues. An autonomous vehicle may not be able to detect such situations because of limitations of sensor systems or lack of access to the information distribution means (e.g., no direct communication with weather agency). An operator at the oversight system may push such information to affected autonomous vehicles that are in communication with the oversight system. The affected autonomous vehicles may proceed to alter their route, trajectory, or speed in response to the information pushed from the oversight system. In some instances, the information received by the oversight system may trigger a threshold condition indicating that MRC (minimal risk condition) maneuvers are warranted; alternatively, or additionally, an operator may evaluate a situation and determine that an affected autonomous vehicle should perform an MRC maneuver and subsequently send such instructions to the affected vehicle. In these cases, each autonomous vehicle receiving either information or instructions from the oversight system or the oversight system operator uses its on-board computing unit (e.g. VCU) to determine how to safely proceed, including performing an MRC maneuver that includes pulling-over or stopping.

Other interactions that the remote center operator (RCO) may have with an autonomous vehicle or a fleet of autonomous vehicle includes any of the following: pre-planned event avoidance; real-time route information updates; real-time route feedback; trail hookup status; first responder communication request handling; notification of aggressive surrounding vehicle(s); identification of construction zone changes; status of an autonomous vehicle with respect to its operational design domain (ODD), such as alerting the RCO when an autonomous vehicle is close to or enters a status out of ODD; RCO notification of when an autonomous vehicle is within a threshold distance from a toll booth and appropriate instruction/communication with the autonomous vehicle or toll authority may be sent to allow the autonomous vehicle to bypass the toll; RCO notification of when an autonomous vehicle bypasses a toll; RCO notification of when an autonomous vehicle is within a threshold distance from a weigh station and appropriate instruction/communication with the autonomous vehicle or appropriate authority may be sent to allow the autonomous vehicle to bypass the weigh station; RCO notification of when an autonomous vehicle bypasses a weigh station; notification to the autonomous vehicle from the RCO regarding scheduling or the need for fueling or maintenance; RCO authorization of third-party access to an autonomous vehicle cab; ability of an RCO to start/restart an autonomous driving system (ADS) on a vehicle; ability of an administrator (possibly an RCO) to set roles for system users, including ground crew, law enforcement, and third parties (e.g., customers, owners of the cargo); support from a RCO for communication with a service maintenance system with fleet vehicles; notification to the RCO from an autonomous vehicle of acceleration events; instruction from a RCO to an autonomous vehicle to continue its mission even when communication is interrupted; RCO monitoring of an autonomous vehicle during and after an MRC maneuver is executed; support for continuous communication between an autonomous vehicle and a yard operator at facility where the autonomous vehicle is preparing to begin a mission or where the autonomous vehicle is expected to arrive; oversight system monitoring of software systems on an autonomous vehicle and oversight system receiving alerts when software systems are compromised; and the like.

An oversight system or command center may allow a third party to interact with the oversight system operator, with an autonomous truck, or with both the human system operator and an autonomous truck. A third party may be a customer whose goods are being transported, a law enforcement or emergency services provider, or a person assisting the autonomous truck when service is needed. In its interaction with a third party, the oversight system may recognize different levels of access, such that a customer concerned about the timing or progress of a shipment may only be allowed to view status updates for an autonomous truck, or may able to view status and provide input regarding what parameters to prioritize (e.g., speed, economy, maintaining originally planned route) to the oversight system. By providing input regarding parameter prioritization to the oversight system, a customer can influence the route and/or operating parameters of the autonomous truck.

Actions that an autonomous vehicle, particularly an autonomous truck, as described herein may be configured to execute to safely traverse a course while abiding by the applicable rules, laws, and regulations may include those actions successfully accomplished by an autonomous truck driven by a human. These actions, or maneuvers, may be described as features of the truck, in that these actions may be executable programming stored on the VCU 150 (the in-vehicle control computer unit). These actions or features may include those related to reactions to the detection of certain types of conditions or objects such as: appropriate motion on hills; appropriate motion on curved roads, appropriate motion at highway exits; appropriate motion or action in response to: detecting of one or more stopped vehicle, detecting one or more vehicles in an emergency lane; detecting an emergency vehicle with flashing lights that may be approaching the autonomous vehicle; motion in response to detecting one or more large vehicles approaching, adjacent to, or soon, to be adjacent to the autonomous vehicle; motions or actions in response to pedestrians, bicyclists, and the like after identification and classification of such actors; motions or actions in response to curved or banked portions of the roadway; and/or motions in response to identifying on and off ramps on highways or freeways, encountering an intersection; execution of a merge into traffic in an adjacent lane or area of traffic; detection of need to clean one or more sensor and the cleaning of the appropriate sensor; identification of law enforcement/emergency vehicles and personnel and compliance with associated instructions or regulations; execution of minimal risk condition maneuvers when needed; and identification of road debris or unknown objects; and the like. Other features of an autonomous truck may include those actions or features which are needed for any type of maneuvering, including that needed to accomplish the features or actions that are reactionary, listed above.

Supporting features may include: changing lanes safely; operating turn signals on the autonomous truck to alert other drivers of intended changes in motion; biasing the autonomous truck in its lane (e.g., moving away from the center of the lane to accommodate the motions or sizes of neighboring vehicles or close objects); ability to maintain an appropriate following distance; the ability to turn right and left with appropriate signaling and motion, and the like. Supporting features may also include: the ability to navigate roundabouts; the ability to properly illuminate with on-vehicle lights as-needed for ambient light and for compliance with local laws; apply the minimum amount of deceleration needed for any given action; determine location at all times; adapting dynamic vehicle control for trailer load distributions, excluding wheel adjustment; launching (reaching target speed), accelerating, stopping, and yielding; operate on roadways with bumps and potholes; enter a minimal risk condition (MRC) on roadway shoulders; access local laws and regulations based on location along a route; operate on asphalt, concrete, mixed grading, scraped road, and gravel; ability to operate in response to metering lights/signals at on-ramps; operate on a roadway with a width up to a pre-determined width; able to stop at crosswalks with sufficient stopping distance; navigate two-way left turn lanes; operate on roadways with entry and exit ramps; utilize the vehicle horn to communicate with other drivers; and the like. One or more features and/or one or more supporting features described in this patent document may combined and can be performed by the in-vehicle control computer in an autonomous truck.

In some embodiments, the actions or features may be considered supporting features and may include: speed control; the ability to maintain a straight path; and the like. These supporting features, as well as the reactionary features listed above, may include controlling or altering the steering, engine power output, brakes, or other vehicle control subsystems 146. The reactionary features and supporting features listed above are discussed in greater detail below.

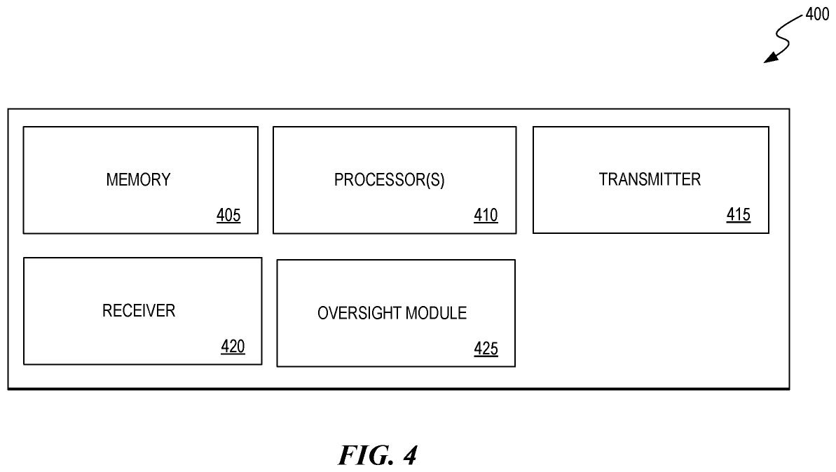

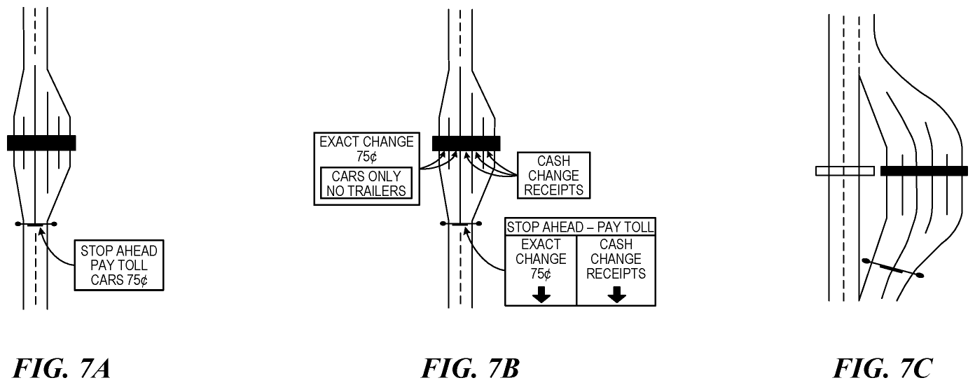

FIG. 4 shows an exemplary block diagram of a remote computer 400 associated with an oversight system. The oversight system (shown as 350 in FIG. 3) may include the remote computer 400 which can be located at a fixed location outside of an autonomous vehicle. In this patent document, the descriptions related to operations performed by the oversight system can be performed by the oversight module (shown as 425 in FIG. 7) in the remote computer 400. The remote computer 400 includes at least one processor 410 and a memory 405 having instructions stored thereupon. The instructions, upon execution by the processor 410, configure the remote computer 400 to perform the operations related to the oversight module 425, where the oversight module 425 can perform operations related to the oversight system as described at least in FIGS. 1 to 3 and in the various embodiments described in this patent document. A remote computer 400 may include one or more servers. The transmitter 415 transmits or sends information or data to one or more autonomous vehicles, and the receiver 420 receives information or data from one or more autonomous vehicles.

### III. VEHICLE CABIN CAMERA VIEW

An autonomous vehicle may include one or more cameras, sensors, imaging devices, and/or the like that are positioned within an interior of a vehicle cabin of the autonomous vehicle, and the cameras, sensors, imaging devices, and/or the like are configured to collect sensor data that captures the internal environment of the vehicle cabin. For example, the collected sensor data may include image or video data for monitoring one or more human operators of the autonomous vehicle that are located within the vehicle cabin. In some examples, image processing operations may be automatically performed to blur or obstruct the faces of the human operators to preserve the privacy of the human operators. As another example, the collected sensor data may include temperature data for monitoring a temperature of the vehicle cabin. As yet another example, the collected sensor data may include gas composition data for detecting fault conditions such as engine smoking, exhaust leakages, or malfunctions. Gas composition data may include CO (carbon monoxide) levels, VOx (volatile organic composition) levels, and the like.

In some embodiments, collected sensor data may be communicated to a computer or autonomous driving system located on the autonomous vehicle that is configured to relay the collected sensor data to an oversight system or a remote computer (e.g., oversight system 350 in FIG. 3, remote computer 400 in FIG. 4). In some embodiments, the on-board computer or system of the autonomous vehicle is configured to collect image or video data of the interior of the vehicle cabin and provide a real-time stream to the oversight system, such that a remote center operator (RCO) may monitor the human operators located in the interior of the vehicle cabin. For example, with the real-time stream, the image or video data is transmitted to the oversight system within a predetermined time (e.g., 0.5 seconds, 1 second, 2 seconds, 5 seconds, 10 seconds) of the image or video data being collected by the cameras, sensors, imaging devices, etc. In some embodiments, the real-time stream may be provided to other remote computers associated with other relevant third parties, such as a staffing entity that contracts the human operators located in the vehicle cabin, a customer entity to which the autonomous vehicle is traveling, a law enforcement entity, and/or the like. In some embodiments, the autonomous vehicle may provide the real-time stream in response to receiving a request to view the interior of the vehicle cabin by the oversight system.

### IV. WEATHER-RELATED VEHICLE OPERATIONS

An autonomous vehicle may be re-routed or caused to perform certain operations in response to relevant weather conditions, or weather conditions located along a planned route for the autonomous vehicle. An autonomous vehicle may be caused to re-route or perform certain operations based on receiving commands from an oversight system or remote computer which may be configured to monitor and analyze weather conditions. For example, the oversight system or remote computer may be configured to interface with a third-party entity that provides or publishes weather data. The oversight system may be configured to automatically collect real-time weather data via an application programming interface (API) and identify autonomous vehicles to whom the real-time weather data is relevant.

Based on a determined or predicted severity of the weather conditions, the oversight system may determine an alternative route for the autonomous vehicle. For example, the oversight system may compare a severity measure (e.g., as determined by the oversight system from obtained weather data, as determined by a weather data provider that generates weather data) with a threshold severity, and based on the severity measure satisfying the threshold severity, the oversight system may determine an alternative route. The alternative route may be configured to completely circumvent areas subject to the severe weather conditions or areas predicted to be subjected to the severe weather conditions. The alternative route may be configured based on predicted movement of severe weather conditions.

In some examples, the autonomous vehicle may (be commanded to) maintain its original route but perform other actions to safely navigate severe weather conditions. For example, the oversight system may command the autonomous vehicle to travel at a lower speed and may establish a maximum speed that is a predetermined amount lower than a speed limit of the roadway. As another example, the oversight system may command the autonomous vehicle to minimize a number of lane changes along its original route, and accordingly, for example, the autonomous vehicle may maintain the same lane along the original route. Thus, for example, the oversight system may restrict certain operations or command the autonomous vehicle to minimize certain operations based on weather conditions relevant to the autonomous vehicle.

### V. HEAVY TRAFFIC OPERATIONS

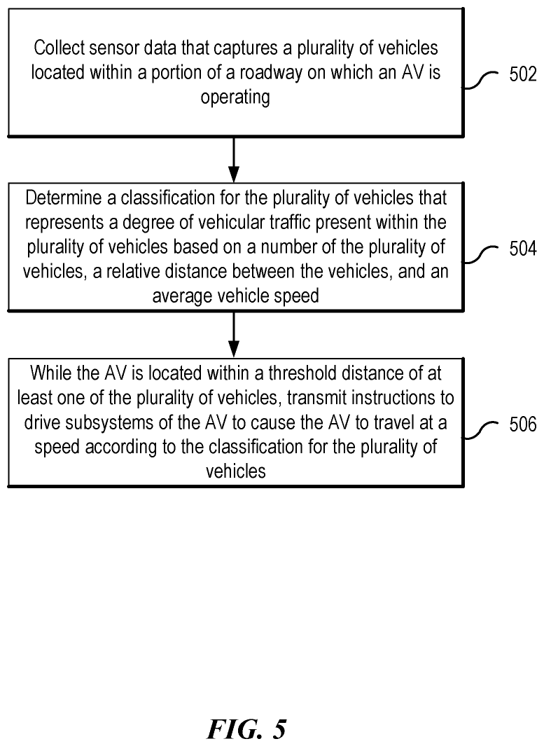

Turning to FIG. 5, a flowchart illustrating operations of an example method for operating an autonomous vehicle is provided. The example method may be performed to operate the autonomous vehicle while the autonomous vehicle is near a high density group of vehicles, such as heavy traffic, a traffic jam, or a line of traffic. For example, the example method may be performed while the autonomous vehicle is passing adjacent to the high density group of vehicles, while the autonomous vehicle is approaching the high density group of vehicles from behind, while the autonomous vehicle is located within the high density group of vehicles, and/or the like.

At an operation 502, sensor data that captures a plurality of vehicles is collected. The plurality of vehicles is located within a portion of a roadway on which an autonomous vehicle is operating. In some examples, the portion of the roadway may be one lane of a plurality of lanes of the roadway, such as a lane in which the autonomous vehicle is located, a lane of the roadway adjacent to a lane in which the autonomous vehicle is located, a toll lane of a toll booth facility, and/or the like. In other examples, the portion of the roadway may be a range of distances along the roadway ahead of a current location of the autonomous vehicle, a range of distances along the roadway in which the autonomous vehicle is currently located, and/or the like.

At an operation 504, a classification for the plurality of vehicles is determined. The classification for the plurality of vehicles represents a degree of vehicular traffic or a degree of vehicle density present within the plurality of vehicles. The classification is determined from the sensor data based on a number of the plurality of vehicles, a relative distance between the vehicles (e.g., an average vehicle-to-vehicle distance), and an average vehicle speed of the plurality of vehicles.

At an operation 506, the autonomous vehicle is operated at a speed according to the classification for the plurality of vehicles while the autonomous vehicle is located within a threshold distance of at least one of the plurality of vehicles. For example, while the autonomous vehicle is located within the threshold distance of at least one of the plurality of vehicles, instructions are transmitted by the control computer to one or more drive subsystems of the autonomous vehicle over a subsystem interface, and the instructions are configured to cause the one or more drive subsystems to operate to cause the autonomous vehicle to travel at a speed that corresponds to the classification for the plurality of vehicles.

In some embodiments, the plurality of vehicles or the at least one vehicle is located ahead of a current location of the autonomous vehicle, and the transmitted instructions include instructions configured to cause the drive subsystems to operate to cause the autonomous vehicle includes causing the autonomous vehicle to decelerate to the speed. For example, the autonomous vehicle may be caused to decelerate at a rate based on the threshold distance. In some embodiments, the speed is determined based on a sensor uncertainty value associated with sensors located on the autonomous vehicle and via which the sensor data was collected.

In some embodiments, the example method further includes receiving a map update configured to cause a determination of a classification for vehicles located within the portion of the roadway. In some embodiments, the map update may be received from a remote computer (e.g., remote computer 400 in FIG. 4) located at a location outside of the autonomous vehicle, and the map update may include a previous classification for vehicles located within the portion of the roadway. In some embodiments, the method further includes providing an indication of the classification for the plurality of vehicles to the remote computer as part of a map survey updated. In some embodiments, the method further includes providing an indication of the classification for the plurality of vehicles to a second autonomous vehicle that is associated with a route that extends through the portion of the roadway.

In some embodiments, the example method further operating hazard lights of the autonomous vehicle prior to the autonomous vehicle being located within the threshold distance of the at least one of the plurality of vehicles. For example, the hazard lights are operated during a deceleration of the autonomous vehicle.

In some embodiments, the portion of the roadway may include a toll booth facility, and various operations related to interacting with a toll booth facility may be performed in conjunction with operations disclosed in this section. For example, the example method may further include identifying a starting point of the toll booth facility and a plurality of toll lanes associated with the toll booth facility and selecting a particular toll lane of the plurality of toll lanes. The starting point of the toll booth facility may be identified as a point along the roadway at which a pair of lateral roadway boundaries have a diverging angle greater than a predetermined threshold angle, and the particular toll lane is selected based on a presence of an electronic toll collection device located on the autonomous vehicle. The portion of the roadway may be a toll lane of a toll booth facility, and the speed may be a complete stop based on the at least one of the plurality of vehicles being at a complete stop at a toll booth associated with the toll lane.

V.(a) Heavy Traffic Definition

An autonomous vehicle may identify heavy traffic on a roadway, such as a highway, when various conditions are met. In some embodiments, the autonomous vehicle identifies heavy traffic when the following three conditions are met: (i) vehicles are located in every lane of the roadway, excluding lanes that lead to an exit from the roadway or lanes that are blocked off due to construction; (ii) the average speed of vehicles in these lanes is less than or equal to a predetermined speed (e.g., 20 miles per hour, 30 miles per hour, 40 miles per hour); and (iii) the average bumper-to-bumper longitudinal distance between consecutive vehicles in each of these lanes is less than a predetermined distance (e.g., 15 meters, 20 meters, 25 meters, 30 meters, 35 meters). The predetermined speed against which the average speed of vehicles is compared may be based on a speed limit for the roadway.

V.(b) Traffic Jam Definition

An autonomous vehicle may identify a traffic jam on a roadway, such as a highway, when various conditions are met. In some embodiments, the autonomous vehicle identifies a traffic jam when the following three conditions are met: (i) vehicles are located in every lane of the roadway, excluding lanes that lead to an exit from the roadway or lanes that are blocked off due to construction; (ii) the average speed of vehicles in these lanes is less than or equal to a predetermined speed (e.g., 8 miles per hour, 10 miles per hour, 12 miles per hour, 15 miles per hour); and (iii) the average bumper-to-bumper longitudinal distance between consecutive vehicles in each of these lanes is less than a predetermined distance (e.g., 8 meters, 10 meters, 12 meters, 14 meters). The predetermined speed against which the average speed of vehicles is compared may be based on a speed limit for the roadway. In some embodiments, the predetermined speed for identifying a traffic jam is lower than the predetermined speed for identifying heavy traffic, and the predetermined bumper-to-bumper distance for identifying a traffic jam is lower than the predetermined speed for identifying heavy traffic. Thus, in some embodiments, a traffic jam is identified as a roadway traffic condition of higher vehicle density than heavy traffic.

V.(c) Line of Traffic Definition

An autonomous vehicle may identify a line of traffic on a roadway, such as a highway, when various conditions are met. In some embodiments, the autonomous vehicle identifies a line of traffic when the following three conditions are met: (i) multiple vehicles are located in any one specific lane of the roadway, including lanes that lead to an exit from the roadway; (ii) the average speed of vehicles in the lane is less than or equal to a predetermined speed (e.g., 8 miles per hour, 10 miles per hour, 12 miles per hour, 15 miles per hour); and (iii) the average bumper-to-bumper longitudinal distance between consecutive vehicles in the lane is less than a predetermined distance (e.g., 8 meters, 10 meters, 12 meters, 14 meters).

In some embodiments, the autonomous vehicle may update an identification of multiple lines of traffic in adjacent lanes on the roadway as an identification of a traffic jam. In some embodiments, the autonomous vehicle identifies a traffic jam based on identifying a line of traffic for each lane of the roadway.

V.(d) Surrounding Vehicles

When identifying traffic jams, heavy traffic, and/or lines of traffic, an autonomous vehicle may take into account the number of vehicles, the spacing between the vehicles, and the speed at which the vehicles are traveling.

V.(e) Detection Distance

An autonomous vehicle may be able to identify or perceive heavy traffic, traffic jams, and lines of traffic from at least a predetermined distance (e.g., 200 meters, 250 meters, 300 meters) or a distance required to come to a complete stop under constant deceleration of a predetermined rate (e.g., −1.25 m/s², −1.5 m/s², −1.75 m/s², −2.0 m/s²), unless upcoming vehicles and portions of roadway are occluded due to horizontal and/or vertical curvatures. Upon identification of heavy traffic, traffic jams, and lines of traffic that are within the detection distance from the autonomous vehicle, the autonomous vehicle may travel at a speed based on the identification.

V.(f) Maximum Passing Speed

When an autonomous vehicle is driving in heavy traffic, a traffic jam, or a lane adjacent to a line of traffic, the autonomous vehicle may maintain a relative velocity with nearby vehicles that is less than a predetermined value (e.g., 15 miles per hour, 20 miles per hour, 25 miles per hour, 30 miles per hour).

V.(g) Map—Live Traffic Data

An autonomous vehicle may receive map updates based on live traffic data that indicates when there is heavy traffic or a potential slow down up ahead, and the live traffic data of the map updates may be obtained via an application programming interface (API). Similarly, an autonomous vehicle may generate and transmit map updates based on traffic data identified by the autonomous vehicle. In some embodiments, an autonomous vehicle may identify heavy traffic, a traffic jam, or a line of traffic, and the autonomous vehicle may communicate an indication thereof to one or more other vehicles, such as another autonomous vehicle traveling along the same roadway. Live traffic data may be provided by an oversight system or remote control center. Another autonomous vehicle in communication with the autonomous vehicle may provide live traffic data.

V.(h) Traffic Compute Ability

An autonomous vehicle may have the computational ability to monitor at least a predetermined number of vehicles that are in front of the autonomous vehicle in every driving lane.

V.(i) Relax the Target Gap

When changing lanes in heavy traffic or a traffic jam, an autonomous vehicle may relax the target front and target back gap tolerances such that the autonomous vehicle can complete a lane change as long as the gap in the target lane is larger than the entire length of the autonomous vehicle (e.g., including a trailer), plus an additional buffer of a predetermined number of meters in each of the forward and rear directions to account for sensor and localization uncertainty. The relaxation in target gap may be possible due to a reduced velocity of the autonomous vehicle and surrounding vehicles (e.g., NPCs) and the relaxation of the target gap may occur when the velocity of the autonomous vehicle and/or the surrounding vehicles falls below a threshold value.

V.(j) Stopped and Following Distance

When following vehicles in heavy traffic, traffic jams, or lines of traffic, an autonomous vehicle may maintain a minimum following distance. The minimum following distance is configured to allow room for the autonomous vehicle to avoid a collision by either coming to a velocity, including a complete stop, such that the autonomous vehicle is not expected to collide with a vehicle ahead of the autonomous vehicle. The minimum following distance may be defined to enable changes in trajectory out of the current lane without colliding with the leading vehicle.

When both the leading vehicle and an autonomous vehicle come to a stop due to heavy traffic, traffic jams, and lines of traffic, the autonomous vehicle may maintain a recommended stopped distance. The recommended stopped distance is configured to leave space for the autonomous vehicle to change lanes from a stationary or stopped position and to prevent other vehicles from cutting in. Thus, with the recommend stopped distance, the autonomous vehicle will have enough room to maneuver around the lead vehicle if needed or desired.

V.(k) Planned Exit with Line of Traffic

If an autonomous vehicle is approaching its intended exit and the autonomous vehicle identifies a line of traffic that extends onto the shoulder, the autonomous vehicle may travel to (e.g., pull over to) a shoulder portion of the roadway and wait in line behind the last vehicle of the line of traffic so as to avoid blocking the non-exit driving lanes of the highway.

V.(l) Hazard Lights

When slowing down for heavy traffic, a traffic jam, or a line of traffic, an autonomous vehicle may turn on the hazard lights to warn other drivers. In some embodiments, the autonomous vehicle may turn on the hazard lights when slowing down for heavy traffic, a traffic jam, or a line of traffic and the speed of the autonomous vehicle is more than a predetermined number (e.g., 15 miles per hour, 18 miles per hour, 20 miles per hour, 22 miles per hour, 25 miles per hour) below a speed limit of the roadway or is below a predetermined threshold speed (e.g., 30 miles per hour, 35 miles per hour, 40 miles per hour, 45 miles per hour, 50 miles per hour).

The autonomous vehicle may turn off the hazard lights when the autonomous vehicle has reached the vehicles in the heavy traffic, traffic jam, or line of traffic and there are vehicles behind the autonomous vehicle or the autonomous vehicle is no longer in the heavy traffic, whichever event occurs first. In some embodiments, the autonomous vehicle may turn off the hazard lights when it is within a predetermined distance (e.g., 40 meters, 45 meters, 50 meters, 55 meters, 60 meters) of the vehicles in the lane in which the autonomous vehicle is travelling and there are vehicles located behind the autonomous vehicle.

The autonomous vehicle may temporarily turn off the hazard lights when changing lanes and resume the hazard light usage on completion of the lane change.

V.(m) Preemptive Lane Change for Upcoming Exit

When an autonomous vehicle is approaching heavy traffic or a traffic jam and the intended exit for the autonomous vehicle is within a predetermined threshold distance (e.g., 3 miles, 4 miles, 5 miles, 8 miles), the autonomous vehicle may navigate to an exit lane on the roadway that corresponds to the intended exit. For example, the exit lane may be the slowest lane on the roadway, which may be the rightmost lane of the roadway (with respect to the direction of travel) in some geographic regions within which the autonomous vehicle is operating. With navigation to an exit lane (e.g., a slow lane, a rightmost lane), the autonomous vehicle may travel in preparation for the upcoming intended exit.

V.(n) Re-Route when Unable to Change Lanes

When driving in heavy traffic or a traffic jam, if an autonomous vehicle is approaching its intended exit and is unable to change lanes to the exit lane (e.g., slowest lane of traffic, the rightmost lane on example North America roadways) in time to successfully travel through the intended exit, the autonomous vehicle may re-route its trajectory such that the autonomous vehicle can still arrive at the final destination. For example, a plurality of alternative routes that may involve a different exit are determined for the autonomous vehicle.

V.(o) Slow Down Strategy

On detection of heavy traffic, a traffic jam, or a line of traffic in the current driving lane, an autonomous vehicle may begin to slow down and match the speed of the upcoming vehicles. On detection of a line of traffic in an adjacent lane, the autonomous vehicle may slow down to reach a maximum passing speed.

### VI. TOLL BOOTH INTERACTIONS

As an autonomous vehicle operates along a roadway, the autonomous vehicle may encounter various toll booths, toll stations, toll facilities, toll plazas, and/or the like located along the roadway. According to various embodiments described herein, the autonomous vehicle may be configured to communicate with a toll booth and/or detect certain roadway characteristics (e.g., lane topology) related to or near the toll booth such that the autonomous vehicle may continue operating on the roadway without significant interruption or need for manual intervention.

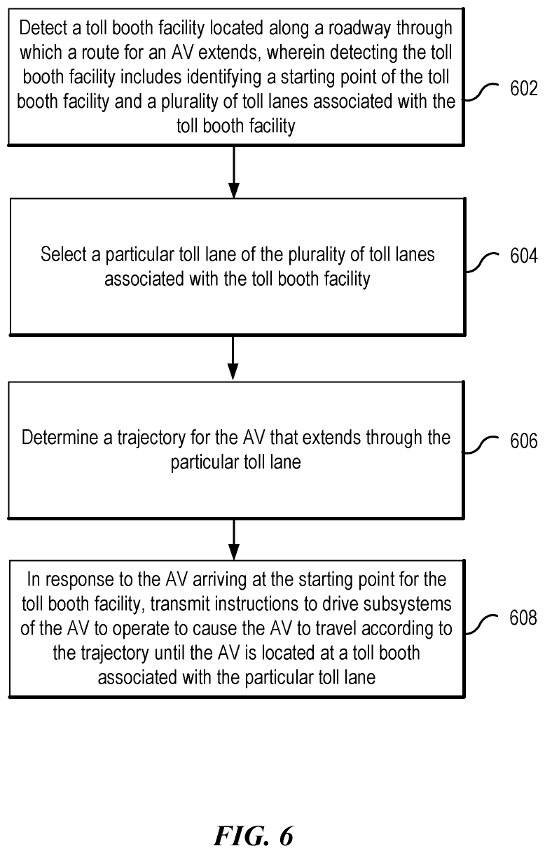

Turning to FIG. 6, a flowchart illustrating operations of an example method for operating an autonomous vehicle is provided. The example method may be performed to operate the autonomous vehicle to handle and navigate a toll booth facility located along the roadway. For example, the example method includes operations that may be performed before arriving at the toll booth facility, while located at the toll booth facility, and while departing from the toll booth facility.

At an operation 602, a toll booth facility located along a roadway through which a route for an autonomous vehicle extends is detected. Detecting the toll booth facility includes identifying a starting point of the toll booth facility along the roadway and identifying a plurality of toll lanes associated with the toll booth facility.

In some embodiments, detecting the toll booth facility includes collecting, by a computer located on the autonomous vehicle (e.g., VCU 150), sensor data that captures an external environment of the autonomous vehicle, and based on the sensor data capturing a road sign located in the external environment that indicates a presence of the toll booth facility, detecting, by the computer located on the autonomous vehicle, the toll booth facility. In some embodiments, detecting the toll booth facility includes receiving, from a remote computer (e.g., remote computer 400 in FIG. 4) located at a location outside of the autonomous vehicle, a message that indicates an upcoming presence of the toll booth facility based on a current location of the autonomous vehicle, and detecting, by a computer located on the autonomous vehicle, the toll booth facility in accordance with the received message. In some embodiments, detecting the toll booth facility includes obtaining, by a computer located on the autonomous vehicle, map data that indicates location of a plurality of toll booth facilities, and based on determining that a current location of the autonomous vehicle is located within a threshold distance of a location of a given toll booth facility of the plurality of toll booth facilities, identifying, by the computer located on the autonomous vehicle, the given toll booth facility as the toll booth facility.

At an operation 604, a particular toll lane of the plurality of toll lanes associated with the toll booth facility is selected. In some embodiments, the particular toll lane is selected according to a toll configuration of the autonomous vehicle that represents a presence of an electronic toll collection device on the autonomous vehicle. In some embodiments, selecting the particular toll lane includes identifying a subset of the plurality of toll lanes based on a toll sign associated with each of the plurality of toll lanes that indicates whether or not each toll lane is closed; and selecting the particular toll lane from the subset of available lanes. In some embodiments, selecting the particular toll lane includes ranking the plurality of toll lanes based on a number of vehicles located in each of the plurality of toll lanes, and selecting the particular toll lane according to the ranking.

At an operation 606, a trajectory for the autonomous vehicle that extends through the particular toll lane is determined. In some embodiments, the trajectory is configured to minimize lateral movement or a number of lane changes for the autonomous vehicle within the roadway. In some embodiments, the trajectory includes a full stop for the autonomous vehicle at the toll booth associated with the particular toll lane. In some embodiments, the trajectory includes a full stop for the autonomous vehicle before the toll booth while another vehicle is located at the toll booth associated with the particular toll lane.

At an operation 608, the autonomous vehicle is caused to travel in accordance with the trajectory in response to the autonomous vehicle arriving at the starting point of the toll booth facility. The autonomous vehicle is caused to travel in accordance with the trajectory until the autonomous vehicle is located at a toll booth associated with the particular toll lane. For example, in response to the autonomous vehicle arriving at the starting point for the toll booth facility, a plurality of instructions are transmitted by the control computer to drive subsystems of the autonomous vehicle over a subsystem interface, and the plurality of instructions are configured to cause the drive subsystems to operate together to cause the autonomous vehicle to travel in accordance with the trajectory until the autonomous vehicle is located at a toll booth associated with the particular toll lane.

In some embodiments, the example method includes further operations including, subsequent to being located at the toll booth associated with the particular toll lane, receiving a message that indicates a status of a toll payment. In some embodiments, the example method further includes, subsequent to being located at the toll booth associated with the particular toll lane, receiving a message indicating a status of a toll payment, and transmitting an indication of the status of the toll payment to a remote computer located at a location outside of the autonomous vehicle. In some embodiments, the example method further includes, subsequent to being located at the toll booth associated with the particular toll lane, determining a status of a toll payment for the autonomous vehicle based on a display of the toll booth.

In some embodiments, the example method further includes subsequent to being located at the toll booth associated with the particular toll lane, determining when to cause the autonomous vehicle to travel past the toll booth based on a detected presence of one or more vehicles located at one or more other toll booths associated with one or more other toll lanes of the toll booth facility.

VI.(a) Available Toll Booths Identification

An autonomous vehicle may identify and autonomously navigate toll booths that are located along a roadway. For example, an autonomous vehicle may detect a toll booth located along a roadway and determine a trajectory for navigating the toll booth. Toll booth locations may be indicated in map data. Various embodiments are described herein to enable an autonomous vehicle to autonomously navigate toll booths in compliance with various operating requirements associated with the toll booths. Instructions for autonomous operation related to a toll booth may be determined in accordance with various embodiments described herein. In some embodiments, the instructions may be determined based on identification or detection of an upcoming toll booth. Alternatively, or additionally, the instructions may be pre-determined based on a toll booth being located along a predetermined route for the autonomous vehicle.

VI.(b) Toll Booth Facility Examples

A toll booth facility or toll booth plaza may be an area in which the toll booths are located to collect a toll (manually or electronically) from vehicles in transit. In some cases, the toll booth facility may comprise an inspection or a check point at which a law enforcement officer may want vehicles to slow down for inspection such as an immigration inspection or an agricultural inspection. In some cases, the toll booth may be a temporary setup such as a sobriety check point along a highway that is temporarily set up during certain holiday times. In some examples, a toll booth facility is used herein to include controlled road barriers or gates. Thus, across various examples, a toll booth facility or a toll booth may regulate vehicular access to further portions of roadway according to various criteria or conditions (e.g., payment of a toll payment, inspection of passengers and/or cargo).

The starting or entrance point of a toll booth facility may be identified where the normal highway lanes start to spread out into multiple toll lanes or the distance to the toll booth is indicated by a traffic sign. Thus, in some embodiments, an autonomous vehicle may identify the starting or entrance point of a toll booth facility based at least on identifying an increase in a number of lanes on the roadway and/or identifying a traffic sign indicating the toll booth facility. In some examples, the starting point of the toll booth facility is identified as a point at which the traffic sign indicating the toll booth facility is located. In some examples, the starting point of the toll booth facility is identified as a point along the roadway at which lateral roadway boundaries of the roadway begin diverging at an angle greater than a threshold angle.

The ending point of a toll booth facility is identified where the multiple toll lanes start to merge into the normal highway lanes. For example, in some embodiments, an autonomous vehicle may detect an ending point of a toll booth facility based at least on detecting a decrease in a number of lanes on the roadway.

Once identified by an autonomous vehicle or a mapping vehicle, the locations of the starting point and stopping point of each toll booth facility may be added to the map utilized by the autonomous vehicle for planning and/or navigation. Additionally, the updated map or information regarding the starting and stopping points of each toll booth facility may be provided to any of: other autonomous vehicles in direct communication with the autonomous vehicle (e.g., other autonomous vehicles in a fleet), to an oversight system, and to a remote control center (including a remote control operator (RCO)). An autonomous vehicle approaching a toll booth facility may utilize sensor data to confirm data regarding the toll booth facility provided on a map.

FIGS. 7A-7C provide diagrams that illustrate example toll booth facilities and roadway configurations thereof. As shown in FIG. 7A, a starting point of the toll booth facility can be defined by the point at which roadway lanes spread out into multiple toll lanes, and a toll booth traffic sign is located at this starting point. Accordingly, an autonomous vehicle may determine the starting point of the toll booth facility based on a change in lane configuration and a detection of the toll booth traffic sign. Similarly, in FIG. 7B, a starting point of the toll booth facility can be defined by the point at which roadway lanes spread into multiple toll lanes and at which toll booth traffic signs are located. In FIG. 7B, different toll lanes may be associated with different toll operations and autonomous vehicle configurations (e.g., whether the autonomous vehicle is configured for electronic toll collection). In each of FIG. 7A and FIG. 7B, the toll lanes merge back into roadway lanes at an ending point of the toll booth facility. In some examples, the roadway lanes at the ending point of the toll booth facility match a configuration of the roadway lanes at the starting point of the toll booth facility.

FIG. 7C illustrates another example of a toll booth facility, where toll lanes split off from roadway lanes at a starting point of the toll booth facility. At an ending point of the toll booth facility, the toll lanes rejoin and merge with the roadway lanes.

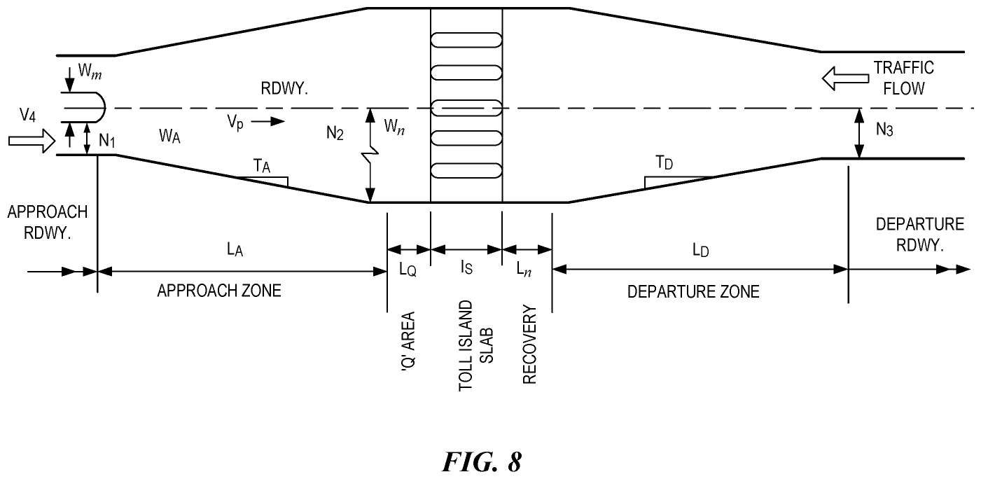

In some examples, toll booth facilities may not spread into multiple lanes, and in such examples, the starting and ending points of a toll booth facility can be considered from the traffic signs that indicate the toll booth speed limit at the beginning of the approach zone and the new speed limit at the end of the departure zone. FIG. 8 is a diagram that illustrates different zones of a toll booth facility. For example, the toll booth facility includes an approach zone spanning along a length of the roadway before the toll booth facility in a direction of travel, and the toll booth facility also includes a departure zone spanning along a length of the roadway after the toll booth facility in the direction of travel. As discussed, the approach zone and the departure zone can be determined based on traffic signs and indicated speed limits. As illustrated in FIG. 8, the approach zone and the departure zone can be determined based on the road boundaries have a diverging or converging angle.

VI.(c) Toll Booth Sign Detection

An autonomous vehicle may detect traffic signs indicating when a toll booth is closed. In some examples, a toll booth facility may include a plurality of toll booths (each corresponding to a lane of travel through the toll booth facility), and the toll booth facility may include signage for each toll booth that indicates whether the toll booth is open or closed. In some examples, the signage for each toll booth is electronic and/or image-based; for example, a display device or an electronic sign is located above each toll booth and may display a positive indicator (e.g., a green arrow) that indicates that the toll booth is open or a negative indicator (e.g., a red cross) that indicates that the toll booth is closed. Accordingly, to determine whether or not a toll booth is closed, the autonomous vehicle may be configured to detect such signage located at a toll booth facility, associate a signage with a toll booth, and analyze data collected from the signage to determine whether the toll booth is closed.

VI.(d) Toll Booth Facility Anticipation

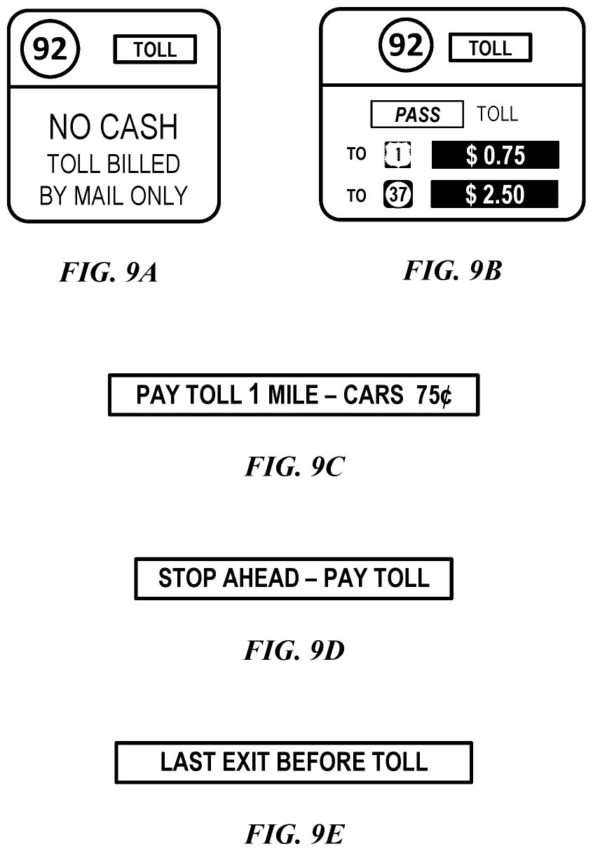

An autonomous vehicle may detect a toll booth traffic sign and begin slowing down at a predetermined distance (e.g., 525 meters, 555 meters, 575 meters, 600 meters) before reaching the toll booth facility. In some examples, the autonomous vehicle may use map data and traffic signs to identify all the toll booths within a route. FIGS. 9A-9E illustrate example road signs via which an autonomous vehicle may identify toll booths. For example, FIGS. 9A-9E illustrate road signs that, when detected by the autonomous vehicle, inform the autonomous vehicle that a toll booth may be upcoming on the roadway.

VI.(e) Approaching Toll Booth

A map used for operating an autonomous vehicle may include traffic sign locations for all toll booth facilities within its path. With at least the map, the autonomous vehicle may identify all or some of the toll booths along a route. As previously disclosed, the autonomous vehicle may also determine that it is approaching a toll booth based on marker signs along the road.

VI.(f) Speed at Toll Booth Facility

An autonomous vehicle may reduce speed gradually according to a speed limit of the toll booth. In some embodiments, the speed limit may be explicitly displayed on roadside signs. In some embodiments, the speed limit may be implicitly posted based on applicable local rules and regulations. In some embodiments, the autonomous vehicle may determine two values: a first value based on implicit or explicit signs for a toll booth, and a second value that is determined without using the fact that the vehicle is nearing a toll booth, but only based on other surrounding driving circumstances such as speeds of neighboring vehicles, and local weather conditions. The autonomous vehicle may select the smaller of these two values as the final actual speed of the autonomous vehicle. In some embodiments, the autonomous vehicle may reduce speed via engine braking as a first option.

VI.(g) Electronic Toll Collection Line Section

An autonomous vehicle may select a toll lane within a toll booth facility according to a toll payment type of the autonomous vehicle. For example, the autonomous vehicle may be configured with an automatic payment type (e.g., Toll Pass ETC). In some embodiments, the autonomous vehicle selects a toll lane at a predetermined distance (e.g., at least 20 meters, at least 35 meters, at least 50 meters, at least 65 meters, at least 80 meters) before the toll booth.

An autonomous vehicle may limit lateral dynamics considering every lateral maneuver (e.g., lane change, lane bias, curbs) depending on trailer inertia and stability criteria.

VI.(h) Toll Path Clearance

An autonomous vehicle may detect obstacles in its trajectory towards the toll booth. In various examples, the obstacles may include speed limiters such as one-way spikes, road bumps or speed bumps, rumble strips, and/or the like through which the autonomous vehicle may travel at a reduced speed. In other examples, the obstacles may include physical barriers such as a gate, a pedestrian, another vehicle, and/or the like through which the autonomous vehicle is not allowed to travel. Accordingly, as the autonomous vehicle detects obstacles in its trajectory, the autonomous vehicle may classify the obstacles according to whether the autonomous vehicle can travel through the obstacles (e.g., at a reduced speed) or not. Upon classification of an obstacle as one through which the autonomous vehicle can travel (e.g., one-way spikes, speed bumps, etc.), the autonomous vehicle may determine a reduced speed for traveling through the obstacle and decelerate prior to arriving at the obstacle.

VI.(i) Waiting in Line

An autonomous vehicle may wait for other vehicles to leave the toll booth before the autonomous vehicle enters the toll booth. For example, at a certain time, the autonomous vehicle may determine that it will be the next vehicle to be processed at the toll booth. Upon determining that the autonomous vehicle will be the next vehicle to be processed at the toll booth, the autonomous vehicle may monitor (e.g., continuously) for the vehicle ahead to leave the toll booth. After detecting that the vehicle ahead of it has left the toll booth area, the autonomous vehicle may control speed of the autonomous vehicle to be at or below a predetermined value and pull into the toll booth area.

VI.(j) Front Distance

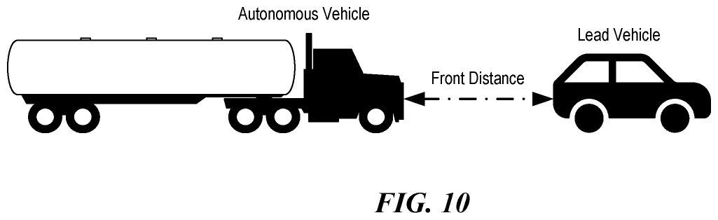

An autonomous vehicle may keep a separation from front vehicle or following distance according to various criteria and logic. Following distance may refer to a front distance in front of the autonomous vehicle and spanning to a vehicle located in front of the autonomous vehicle, as illustrated in FIG. 10. Following distance may be based on a bumper-to-bumper gap, referring a gap or distance between a front bumper of the autonomous vehicle and a rear bumper of a lead vehicle. In some embodiments, an autonomous vehicle may be able to make an instantaneous prediction on the expected target lane front vehicle deceleration, if any. In some embodiments, the autonomous vehicle may define the critical distance with the target front vehicle as the largest gap from the following options: (i) the bumper-to-bumper gap required to maintain at least a threshold confidence measure of sensor coverage; (ii) the bumper-to-bumper gap required to be outside of response time minimums; and (iii) the bumper-to-bumper gap required to avoid a collision under the assumption that both the autonomous vehicle and the target lane front vehicle have to decelerate to a complete stop at the expected deceleration of the target lane front vehicle and the expected reactive deceleration of the autonomous vehicle (this gap may account for reaction time of the autonomous vehicle and may include an additional safety buffer). If the target front vehicle is not expected to decelerate, this gap may be equal to the safety buffer. In some examples, there is a predetermined minimum distance. The autonomous vehicle may not change lanes within the critical distance to the target lane front vehicle.

For all but critical safety lane change intentions, an autonomous vehicle may prefer to change lanes with a bumper-to-bumper gap of at least a predetermined distance (e.g., 10 meters, 12.5 meters, 15 meters, 17.5 meters, 20 meters) with the target front vehicle. The autonomous vehicle may prefer not to change lanes behind a target front slow-moving vehicle.

VI.(k) Full Stop at Toll Booth

Upon approaching the toll booth (e.g., as a vehicle ahead of the autonomous vehicle has left the toll booth), an autonomous vehicle may come to a full stop at a predetermined distance (e.g., 1 meter, 2 meters, 3 meters) from the toll gate when the toll gate is closed.

VI.(l) Speed Ramp-Up after Toll Booth

An autonomous vehicle may increase its speed after passing the toll gate with a predetermined acceleration (e.g., 1 m/s², 1.5 m/s², 2 m/s²) until an allowed speed limit is reached. The allowed speed limit may be based on a speed limit associated with the roadway and external environment conditions, such as weather.

VI.(m) Toll Payment Status

An autonomous vehicle may confirm the toll payment has been registered and report any issue with the payment immediately to an oversight system or remote computer. In some embodiments, the autonomous vehicle may determine the status of the toll payment based on communication with a toll system. For example, the autonomous vehicle may be configured to wirelessly communicate with a toll system positioned at a given toll booth, or a toll system associated with a plurality of toll booths at a toll booth facility. In some embodiments, upon approach to a toll booth, the autonomous vehicle may transmit an indication to a toll system indicating that the autonomous vehicle is under autonomous operation and requesting that toll payment confirmation be provided. In response to the transmitted indication and based on the autonomous vehicle may located at the toll booth, the autonomous vehicle may receive an indication that the toll payment was successful. In some examples, the autonomous vehicle may receive an indication of requested operation; for example, the autonomous vehicle may receive, from a toll system, an indication that the autonomous vehicle needs to travel forward by a specified distance such that toll device of the autonomous vehicle can be scanned by the toll booth. In some examples, for toll lanes that do not require a complete stop of the autonomous vehicle and that are configured to scan a toll device of the autonomous vehicle as the autonomous vehicle travels through the toll lanes, the autonomous vehicle may receive an indication of successful toll payment based on the autonomous vehicle being uniquely associated with the toll device. For example, the toll system may scan the toll device and, based on a unique association between the toll device and the autonomous vehicle, the toll system may transmit a message to the autonomous vehicle.

VI.(n) Available Lanes Detection

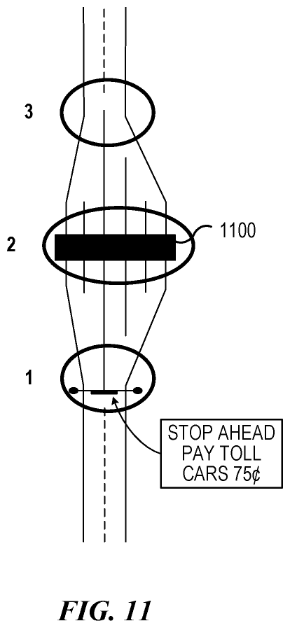

An autonomous vehicle may identify a lane indicated by the map to continue the trip. At a toll booth facility, toll lane layouts may be different from lane layouts before and after the toll booth facility. FIG. 11 illustrates an example of altering toll lane layouts at a toll booth facility 1100. At Area 1 before the toll booth facility 1100, the roadway features a first lane configuration (e.g., two lanes). At Area 2 at the toll booth facility 1100, the roadway includes an increased number of lanes, or a second lane configuration different than the first lane configuration. At Area 3 after the toll booth facility 1100, the roadway includes a lane configuration different than that of Area 2. In some examples, the lane configuration at Area 3 is the same as the lane configuration at Area 1. In some examples, some toll lanes (e.g., at Area 2) may be out of service, shut down for maintenance and construction, closed due to accidents, or the like. Accordingly, in some embodiments, the autonomous vehicle is configured to dynamically detect available lanes at points before, at, and after a toll booth facility.

In some embodiments, an autonomous vehicle may select one of the detected available lanes based on a presence of other vehicles in each of the detected available lanes. For example, the autonomous vehicle may rank the detected available lanes based on a number of other vehicles located in each detected available lane. According to the ranking, the autonomous vehicle may select an available toll lane that has a minimum number of other vehicles. In some embodiments, the autonomous vehicle may select one of the detected available lanes based on the roadway lane in which the autonomous vehicle is located before arriving at the toll booth facility. For example, if the autonomous vehicle is located in the right-most lane of the roadway before arriving at the toll booth facility, the autonomous vehicle may select an available toll lane located on a right-side of the toll booth facility over another available toll lane located on a left-side of the toll booth facility, thereby minimizing a degree of lateral movement of the autonomous vehicle when traveling through the toll booth facility.

VI.(o) Departing from Toll Booth

An autonomous vehicle may ensure a safe departure from a toll booth based on determining that there are no objects, including a toll gate, NPC vehicles (e.g., surrounding vehicles), persons, or the like, blocking a departure path from the toll booth. As shown in FIGS. 7A-7C, toll lanes departing from a toll booth facility may merge with or into lanes of a roadway, and similar to an expanding number of lanes at a starting point of the toll booth facility, an ending point of the toll booth facility may feature a condensing or reduction of the number of lanes. Accordingly, as the autonomous vehicle departs from the toll booth, the autonomous vehicle may select a roadway lane to which the autonomous vehicle will travel. The autonomous vehicle may prefer the slowest lane of traffic (e.g., the right-most lane of the roadway in areas where traffic drives on the right-hand side of the road) after the ending point of the toll booth facility, or a lane of the roadway that would require the least amount of lateral movement from the current position of the autonomous vehicle at the toll booth. As the autonomous vehicle determines a trajectory to the selected lane of the roadway that is located beyond the ending point of the toll booth facility, the autonomous vehicle may identify whether other toll lanes of the toll booth facility other than the toll lane in which the autonomous vehicle is current located merges into the selected lane. In accordance with a determination that one or more other toll lanes merge with the selected lane of the roadway, the autonomous vehicle may monitor a presence of other vehicles in the other toll lanes and may yield to the other vehicles if the other vehicles departed from their respective toll booths before the autonomous vehicle has departed from the toll booth.

VI.(p) Lane Change Required

If a lane change is required while navigating the toll booth facilities, an autonomous vehicle may perform a lane change. For example, upon determination that a toll booth that the autonomous vehicle was targeting becomes closed, the autonomous vehicle may target another toll booth and perform a lane change. As another example, upon determination that a vehicle is located at a toll booth for at least a threshold amount of time, the autonomous vehicle may target another toll booth and perform a lane change. Such lane changes may be performed subsequent to the autonomous vehicle selecting a particular toll lane and monitoring the toll booth associated with the particular toll lane. For example, after selecting a particular toll lane, the autonomous vehicle may monitor whether the toll booth remains open as the autonomous vehicle approaches the toll booth until the autonomous vehicle has reached the toll booth. With the monitoring, if the autonomous vehicle determines that the toll booth has become closed (e.g., via a toll sign indicating an open/closed status of the toll booth), the autonomous vehicle may perform the lane change.

VI.(q) Collision Avoidance at Toll Booth Facilities

An autonomous vehicle may detect and avoid collisions with any pedestrians, obstacles, and vehicles within the toll booth facilities by keeping a predetermined safe distance (e.g., 1 meter, 2 meters, 3 meters) from these objects. For example, an autonomous vehicle may maintain a distance from a pedestrian or a toll booth attendant to avoid running them over. In some examples, a predetermined safe distance maintained by the autonomous vehicle from objects at a toll booth facility is based on object types, such as a vehicle object type, a person object type (e.g., a pedestrian, a toll booth attendant, etc.), an environment object type (e.g., the toll booth itself, guardrails, gates, etc.)

VI.(r) Yield Sign Detection

An autonomous vehicle may detect if a yield sign is present or if yielding is required for other vehicles that are also leaving the toll booth.

Electronic toll collections (ETC) lanes with favorable geometrics typically allow vehicles to move through the toll plaza without stopping, but usually within a set regulatory speed limit or advisory speed. The autonomous vehicle may determine different trajectories or operations based on whether the autonomous vehicle is located in or is targeting an ETC toll lane or a non-ETC toll lane.

VI.(s) Path Clearance Confirmation

In some examples, an obstacle, vehicle, or pedestrian may block a trajectory of the autonomous vehicle as the autonomous vehicle departs from the toll booth facility. Upon detection of such a blocking obstacle, the autonomous vehicle may come to a complete stop and monitor movement of the blocking obstacle. An autonomous vehicle may resume its route once a blocking obstacle, vehicle, or pedestrian has been cleared from a trajectory of the autonomous vehicle, for example, once the blocking obstacle is located at a predetermined distance away from the trajectory of the autonomous vehicle.

### VII. MINIMAL RISK CONDITION OPERATIONS

An autonomous vehicle may receive a command to initiate a minimal risk condition (MRC) maneuver from an oversight system or a remote computer (e.g., oversight system 350 in FIG. 3, remote computer 400 in FIG. 4). The oversight system or remote computer may initiate the MRC maneuver for the autonomous vehicle for various reasons, such as a determination of a fault condition at the autonomous vehicle based on sensor data received from the autonomous vehicle, a request from a law enforcement entity to inspect the autonomous vehicle, a severe weather event, or the like. In some embodiments, the command to initiate an MRC maneuver may be transmitted from the oversight system or remote computer to the autonomous vehicle with a high priority, such that the autonomous vehicle receives and processes the autonomous vehicle within a predetermined amount of time.

In some embodiments, the oversight system or remote computer may transmit a batch of MRC commands to a plurality of autonomous vehicles so that each of the plurality of autonomous vehicles are caused to perform an MRC maneuver. For example, the oversight system or remote computer may identify a severe weather event relevant to a geographic region and may accordingly transmit a batch of MRC commands to all autonomous vehicles located in the geographic region, all autonomous vehicles having a route that travels through the geographic region, all autonomous vehicle located within a threshold distance of the geographic region, and/or the like. As another example, the oversight system or remote computer may identify a heavy traffic event at a portion of a roadway and may transmit a batch of MRC commands to all autonomous vehicles that are planned to travel through the portion of the roadway so that the oversight system has time to plan alternative routes for each autonomous vehicle.

In some examples, the oversight system or remote computer may cause a plurality of autonomous vehicles to perform MRC maneuvers based on vehicle-to-vehicle communication propagation. For example, the oversight system may transmit a batch MRC command to a leader autonomous vehicle, and upon receiving the batch MRC command, the leader autonomous vehicle may transmit individual MRC commands to one or more other autonomous vehicles associated with the leader autonomous vehicle. Similarly, the oversight system may transmit a batch MRC command to a particular autonomous vehicle, and the particular autonomous vehicle may be configured to communicate with other autonomous vehicles within a predetermined radius to cause the other autonomous vehicles to perform MRC maneuvers. Accordingly, the oversight system may efficiently cause a group, fleet, or a plurality of autonomous vehicles to each perform MRC maneuvers through a batch MRC command to one autonomous vehicle that is then relayed or propagated to the other autonomous vehicles.

### VIII. EMERGENCY FREE SPACE DISENGAGEMENT

After executing a minimal risk condition (MRC) maneuver (operations configured to allow an autonomous vehicle to reach a minimal risk condition, such as a complete stop), an autonomous vehicle may be located at an emergency free space. For example, the minimal risk condition for the autonomous vehicle may be defined as a complete stop at an emergency free space, such as a shoulder area off of the roadway or a right-most lane of the roadway (e.g., the lane which is the slowest lane of traffic for a roadway based on a jurisdiction in which the roadway is located).

As the autonomous vehicle is located in the emergency free space, the fault condition that triggered the MRC maneuver may be resolved, and the autonomous vehicle may need to leave the emergency free space and re-embark on the roadway to continue its route. For example, the autonomous vehicle leaves the emergency free space after executing an MRC maneuver and recovering.

The departure from the emergency free space may be performed in response to a determination that the triggering fault condition has been resolved. In some examples, the autonomous vehicle may receive an indication from an oversight system or remote computer that the fault condition is resolved, for example, when the oversight system or remote computer initiated the MRC maneuver. In some examples, the autonomous vehicle may have initiated the MRC maneuver locally, and the autonomous vehicle may determine that the fault condition that triggered the MRC maneuver has been become irrelevant, become resolved, or become mitigated or less severe. In some examples, a human operator of the autonomous vehicle may have manually examined the fault condition of the autonomous vehicle, and the human operator may provide a user input (e.g., an override code, a PIN) into the autonomous system of the autonomous vehicle to indicate that the fault condition has been resolved. The human operator may be a safety driver or service personnel. A safety driver or service personnel may be dispatched by an oversight system or remote control center to assist and autonomous vehicle that is in MRC, such as an autonomous vehicle that has had to stop due to deterioration in vehicle health, sensor cleaning or alignment issues, a collision, and the like.

In response to the triggering fault condition being resolved, the autonomous vehicle is configured to monitor traffic on the roadway and determine a trajectory that allows the autonomous vehicle to rejoin the traffic on the roadway. The autonomous vehicle may collect sensor data from sensors (e.g., cameras, light detection and ranging sensors) oriented towards a rear of the autonomous vehicle for a predetermined amount of time to observe the approaching traffic. The autonomous vehicle may predict trajectories for detected vehicles that are approaching the autonomous vehicles in order to identify gaps between vehicles into which the autonomous vehicle may travel. The trajectories for the detected vehicles may be predicted using machine learning models, predictive models, extrapolative models, and/or the like.

The autonomous vehicle may also predict a speed of the detected vehicles (e.g., an average speed of the vehicles) and may begin accelerating to a given speed before re-entering the roadway. For example, the autonomous vehicle may accelerate along the emergency free space (e.g., the shoulder area of the roadway) before entering a lane of the roadway.

### IX. CONCLUSION

In order to perform the above features, an autonomous vehicle may utilize any of the sensors, particularly the data obtained from the sensors, in conjunction with the computing facilities on-board the autonomous vehicle, such as those associated with or in communication with the VCU. Alternatively, or additionally, the above features may be executed by an autonomous vehicle with aid from an oversight system, or control center, and optionally with aid from a human remote control operator. The oversight system, and in some cases the remote control operator, may communicate environmental data, map updates, instructions, or other information to an autonomous vehicle. An on-board map, such as a high-definition map, may be used by an autonomous vehicle to accomplish some of the features described herein, particularly when knowledge of location and local regulations (e.g., speed limits, obligations under the law, traffic conventions, intersection types) is needed to complete a task described in the feature.

While this document refers to an autonomous truck, it should be understood that any autonomous ground vehicle may have such features. Autonomous vehicles which traverse over the ground may include: semis, tractor-trailers, 18 wheelers, lorries, class 8 vehicles, passenger vehicles, transport vans, cargo vans, recreational vehicles, golf carts, transport carts, and the like.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

Implementations of the subject matter and the functional operations described in this patent document can be implemented in various systems, semiconductor devices, ultrasonic devices, digital electronic circuitry, or in computer software, firmware, or hardware, including the structures disclosed in this specification and their structural equivalents, or in combinations of one or more of them. Implementations of aspects of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of characteristics that may be specific to particular embodiments or sections of particular inventions. Certain characteristics that are described in this patent document in the context of separate embodiments or sections can also be implemented in combination in a single embodiment or a single section. Conversely, various characteristics that are described in the context of a single embodiment or single section can also be implemented in multiple embodiments or multiple sections separately or in any suitable sub combination. A feature or operation that is described in one embodiment or one section can be combined with another feature or another operation from another embodiment or another section in any reasonable manner. Moreover, although characteristics may be described above as acting in certain combinations and even initially claimed as such, one or more characteristics from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of operating an autonomous vehicle, comprising:
detecting, by a control computer located on the autonomous vehicle based on sensor data obtained over a subsystem interface between the control computer and one or more sensor subsystems of the autonomous vehicle, a toll booth facility that is located along a roadway through which a route for the autonomous vehicle extends,
wherein detecting the toll booth facility comprises identifying a starting point of the toll booth facility on the roadway and a plurality of toll lanes associated with the toll booth facility;
selecting, by the control computer, a particular toll lane of the plurality of toll lanes associated with the toll booth facility;
determining, by the control computer, a trajectory for the autonomous vehicle that extends through the particular toll lane; and
in response to the autonomous vehicle arriving at the starting point for the toll booth facility, transmitting, by the control computer to one or more drive subsystems of the autonomous vehicle over the subsystem interface, a plurality of instructions that are configured to cause the one or more drive subsystems of the autonomous vehicle to operate together to cause the autonomous vehicle to travel in accordance with the trajectory until the autonomous vehicle is located at a toll booth associated with the particular toll lane.

2. The method of claim 1, wherein detecting the toll booth facility comprises:
collecting, by the control computer over the subsystem interface, sensor data that captures an external environment of the autonomous vehicle; and
based on the sensor data capturing a road sign located in the external environment that indicates a presence of the toll booth facility, detecting, by the control computer, the toll booth facility.

3. The method of claim 1, wherein a number of the plurality of toll lanes is greater than a number of lanes of the roadway, and wherein the starting point of the toll booth facility is identified as a point along the roadway at which a number of lanes in the roadway changes.

4. The method of claim 1, wherein the particular toll lane is selected according to a toll configuration of the autonomous vehicle that represents a presence of an electronic toll collection device on the autonomous vehicle.

5. The method of claim 1, further comprising:
subsequent to being located at the toll booth associated with the particular toll lane, receiving a message that indicates a status of a toll payment.

6. The method of claim 1, further comprising:
subsequent to being located at the toll booth associated with the particular toll lane, determining when to cause the autonomous vehicle to travel past the toll booth based on a detected presence of one or more vehicles located at one or more other toll booths associated with one or more other toll lanes of the toll booth facility.

7. The method of claim 1, wherein the trajectory for the autonomous vehicle is configured to minimize lateral movement of the autonomous vehicle within the roadway.

8. The method of claim 1, wherein the trajectory for the autonomous vehicle includes a full stop for the autonomous vehicle at the toll booth associated with the particular toll lane.

9. A system for operating an autonomous vehicle, comprising a computer that includes a processor configured to execute instructions that cause the system to:
detect, based on sensor data obtained over a subsystem interface between the computer and one or more sensor subsystems of the autonomous vehicle, a toll booth facility that is located along a roadway through which a route for the autonomous vehicle extends,
wherein detecting the toll booth facility comprises identifying a starting point of the toll booth facility on the roadway and a plurality of toll lanes associated with the toll booth facility;
select a particular toll lane of the plurality of toll lanes associated with the toll booth facility;
determine a trajectory for the autonomous vehicle that extends through the particular toll lane; and
in response to the autonomous vehicle arriving at the starting point for the toll booth facility, transmit, to one or more drive subsystems of the autonomous vehicle over the subsystem interface, a plurality of instructions that are configured to cause the one or more drive subsystems of the autonomous vehicle to operate together to cause the autonomous vehicle to travel in accordance with the trajectory until the autonomous vehicle is located at a toll booth associated with the particular toll lane.

10. The system of claim 9, wherein detecting the toll booth facility comprises:
receiving, from a remote computer located at a location outside of the autonomous vehicle, a message that indicates an upcoming presence of the toll booth facility based on a current location of the autonomous vehicle; and
detecting the toll booth facility in accordance with the received message.

11. The system of claim 9, wherein the starting point of the toll booth facility is identified as a point along the roadway at which a pair of lateral roadway boundaries of the roadway have a diverging angle greater than a predetermined threshold angle.

12. The system of claim 9, wherein selecting the particular toll lane comprises:
identifying a subset of the plurality of toll lanes based on a toll sign associated with each of the plurality of toll lanes that indicates whether or not each toll lane is closed; and
selecting the particular toll lane from the subset of available lanes.

13. The system of claim 9, wherein the processor is configured to execute instructions to cause the system to further:
subsequent to being located at the toll booth associated with the particular toll lane, receiving a message indicating a status of a toll payment; and
transmitting an indication of the status of the toll payment to a remote computer located at a location outside of the autonomous vehicle.

14. The system of claim 9, wherein the trajectory for the autonomous vehicle is configured to minimize a number of lane changes for the autonomous vehicle.

15. A non-transitory computer readable program storage medium having code stored thereon, the code, when executed by a processor, causing the processor to:
detect, based on sensor data obtained over a subsystem interface between the computer and one or more sensor subsystems of the autonomous vehicle, a toll booth facility that is located along a roadway through which a route for the autonomous vehicle extends,
wherein detecting the toll booth facility comprises identifying a starting point of the toll booth facility on the roadway and a plurality of toll lanes associated with the toll booth facility;
select a particular toll lane of the plurality of toll lanes associated with the toll booth facility;
determine a trajectory for the autonomous vehicle that extends through the particular toll lane; and
in response to the autonomous vehicle arriving at the starting point for the toll booth facility, transmit, to one or more drive subsystems of the autonomous vehicle over the subsystem interface, a plurality of instructions that are configured to cause the one or more drive subsystems of the autonomous vehicle to operate together to cause the autonomous vehicle to travel in accordance with the trajectory until the autonomous vehicle is located at a toll booth associated with the particular toll lane.

16. The non-transitory computer readable program storage medium of claim 15, wherein detecting the toll booth facility comprises:
obtaining, by the control computer, map data that indicates locations of a plurality of toll booth facilities; and
based on determining that a current location of the autonomous vehicle is located within a threshold distance of a location of a given toll booth facility of the plurality of toll booth facilities, identifying, by the control computer, the given toll booth facility as the toll booth facility.

17. The non-transitory computer readable program storage medium of claim 15, wherein the starting point of the toll booth facility is identified as a point along the roadway at which a road sign associated with the toll booth facility is located.

18. The non-transitory computer readable program storage medium of claim 15, wherein selecting the particular toll lane comprises:
ranking the plurality of toll lanes based on a number of vehicles located in each of the plurality of toll lanes; and
selecting the particular toll lane according to the ranking.

19. The non-transitory computer readable program storage medium of claim 15, wherein the code, when executed by the processor, further causes the processor to:
subsequent to being located at the toll booth associated with the particular toll lane, determine a status of a toll payment for the autonomous vehicle based on a display of the toll booth.

20. The non-transitory computer readable program storage medium of claim 15, wherein the trajectory for the autonomous vehicle includes a full stop for the autonomous vehicle before the toll booth associated with the particular toll lane while another vehicle is located at the toll booth.
